(19) United States
(12) Patent Application Publication
(10) Pub. No.: US 2001/0045808 A1
(43) Pub. Date: Nov. 29, 2001

(54) Robot hand flange

(76) Inventors: Gerhard Hietmann, Meitingen (DE); Gerd Rawiel, Augsburg (DE); Joachim Markert, Augsburg (DE)

Correspondence Address: McGLEW AND TUTTLE P.C., SCARBOROUGH STATION, SCARBOROUGH, NY, 10510-0827, US

(21) Appl. No.: 09/863,646

(22) Filed: May 23, 2001

(30) Foreign Application Priority Data
May 27, 2000 (DE) 200 09 543.9

(51) Int. Cl. B25J 9/18; G05B 19/19

(52) U.S. Cl. 318/568.11

(57) ABSTRACT

A robot hand flange has an attached part for receiving an auxiliary device, such as a measuring body, a sensor, an additional or auxiliary tool.

### FIELD OF THE INVENTION

The invention relates to a robot hand flange.

### BACKGROUND OF THE INVENTION

On attaching auxiliary devices, such as sensors, additional or alternative tools with respect to the actual tool on a robot hand or on the actual tool hitherto complicated auxiliary constructions have been necessary requiring gauging and calibration, the replacement of such auxiliary devices being associated with the loss of calibration, so that on again fitting an auxiliary device recalibration has been required. Assembly and disassembly of such parts are consequently very time consuming and their required position can only be reproduced to a limited extent.

This more particularly applies if for determining the position of the hand flange or the tool carried by it a measuring body is provided, which is measured by a separate sensor, with which positions on a workpiece are measured, is to appear under a specific limited angular range, so that the measuring body must be constructed in reproducible and adjustable manner.

Therefore the problem of the invention is to so develop a robot hand flange that, whilst avoiding the aforementioned disadvantages, it is possible to reproducibly fix thereon and with known positions relative thereto auxiliary devices

### SUMMARY OF THE INVENTION

In the case of a robot hand flange the invention solves this problem by an attached part for receiving an auxiliary device, such as a measuring body, a sensor or an additional or auxiliary tool.

Assembly and disassembly of the auxiliary device in a specific position, but also in different, but predetermined positions can be reproduced in time saving manner, in that from the outset an attached part carrying the auxiliary device is fixed at a predetermined and in particular axially established position.

According to a preferred development the auxiliary device is detachably fastened to the hand flange. In a further development the attached part is constructed as a securing ring. According to another preferred development of the invention it has a circumferential groove in which the attached part is held.

The advantage of the invention is mainly the obviating of gauging, because the connecting devices on the ring have calibrated mounting dimensions with respect to the hand flange. If a device is fitted, whose action point or line, which in the case of an optical sensor such as a CCD camera are constituted by the optical axis and the image plane, has a known position relative to the assembly device (screw-on surface, threaded holes, profile foot, etc.), gauging is rendered superfluous, which is particularly important when frequent changes occur.

### BRIEF DESCRIPTION OF THE DRAWINGS

Further advantages and features of the invention can be gathered from the claims and the following description of an embodiment of the invention with reference to the attached drawings, wherein show:

FIG. 1 A side view of a robot with a hand flange constructed according to the invention.

FIG. 2 A perspective overall view of an attached part with an auxiliary device in the form of a measuring body.

FIG. 3 A larger scale view of area II in FIG. 1.

FIG. 4 FIG. 3 a section corresponding to A-A in FIG. 2.

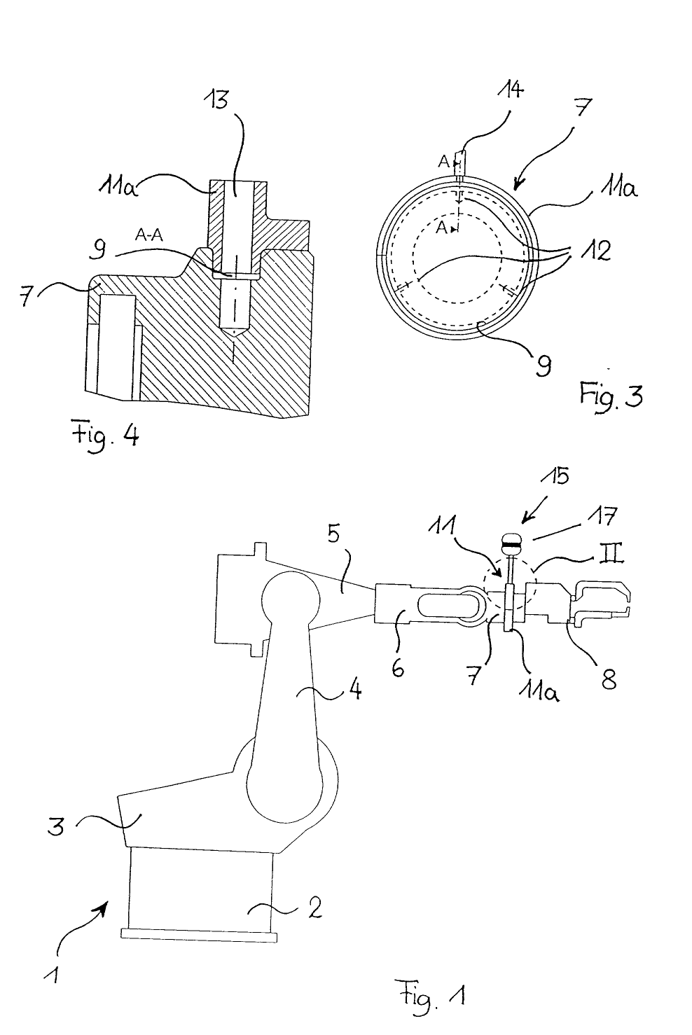

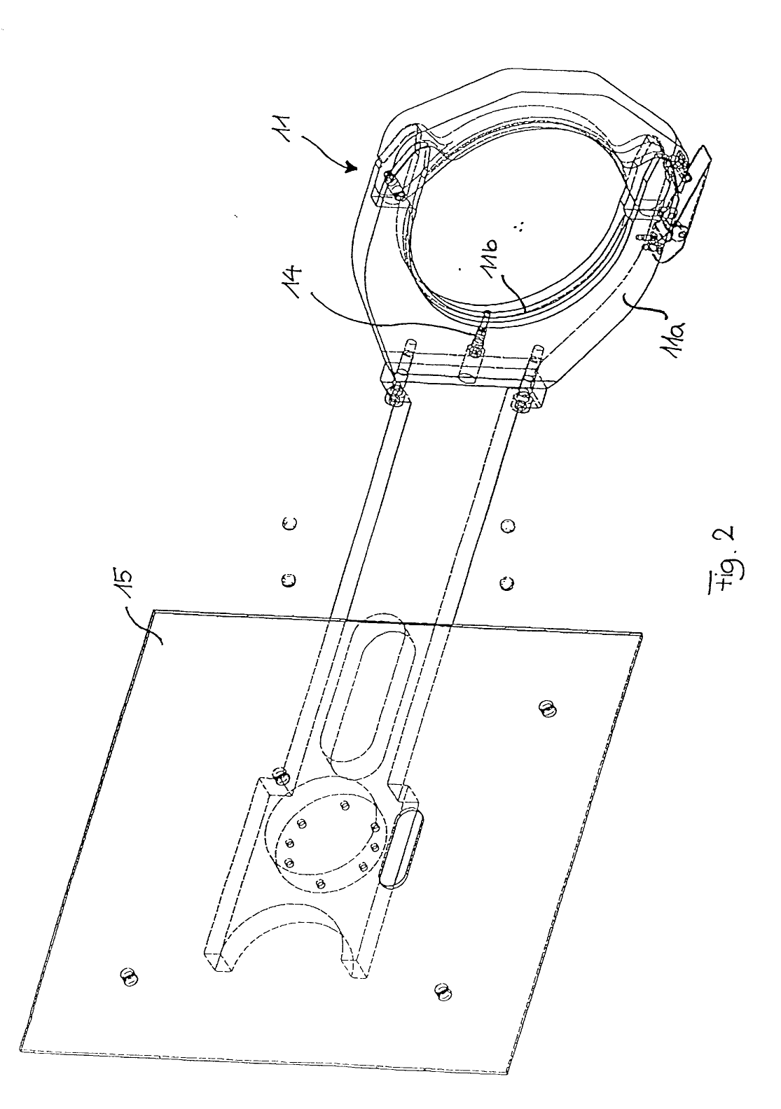

### DETAILED DESCRIPTION OF THE DRAWINGS

The robot 1 constructed according to the invention has the standard, essential mechanical parts, namely the base 2, carousel 3, rocker arm 4, robot arm 5, hand 6 with flange 7 to which is fixed a tool 8 in the form of welding tongs.

The hand flange 7 constructed according to the invention has a circumferential groove 9 in which is located an attached part 11 with a securing ring 11a. The securing ring 11a is necessarily splittable or openable for assembly and disassembly. The securing ring 11a is fixed to the hand flange 7 by means of holes 12 located on the bottom of the groove 9 of said flange 7. The securing ring 11a is here constructed as a hinged clip (FIG. 2).

The securing ring 11a has a hole 13 for receiving a plug-in part 14 of an auxiliary device 15, such as a measuring body, a sensor or an additional or alternative tool with respect to the actual tool 8.

The securing ring 11a can be fully rotated. Fixing in a specific angular position takes place by plugging in using a pin, such as the plug-in part 14, which is plugged radially through a hole 13 in the ring and embedded in a hole 12 in the hand flange 7 determining the angular position. Plugging in can take place both manually and by resilient mounting of the pin 14 in the ring 11a and on rotating the ring 11a is automatically inserted in the next hole in the hand flange 7. The ring is not fixed by screwing.

The three holes shown are only to be understood in exemplified manner and for the complete utilization of the possibilities there can be numerous holes, e.g. in 15° steps.

On the inside of the ring a raised ring projection 11b is constructed as a “tongue”, which is introduced into the groove on the hand flange circumference for forming a groove and tongue joint. In the axial direction the groove and tongue form a fit ensuring a precise axial fixing. After closing the ring it is positively and non-positively engaged on the hand flange circumference.

### LIST OF REFERENCE NUMERALS

1 Robot

2 Base

3 Carousel

4 Rocker arm

5 Robot arm

6 Hand

7 Hand flange

8 Tool

9 Circumferential groove

11 Attached part

11a Securing ring

12 Holes

13 Hole

14 Plug-in part

15 Auxiliary device

1. Robot hand flange, characterized by an attached part for receiving an auxiliary device (18), such as a measuring body, a sensor, an additional or auxiliary tool.

2. Hand flange according to claim 1, characterized in that the auxiliary device (18) is fixed in detachable manner to the hand flange (7).

3. Hand flange according to claim 1, characterized in that the attached part (11) has a securing ring (17a).

4. Hand flange according to claim 1, characterized in that it has a circumferential groove (9) in which is held the attached part (11).

5. Hand flange according to claim 4, characterized by an inner ring projection (11b) on securing ring (11a) forming with the circumferential groove (9) a groove and tongue joint.

6. Hand flange according to claim 3, characterized in that the securing ring (11a) is splittable or openable.

7. Hand flange according to claim 6, characterized in that the securing ring is constructed as a hinged clip.

8. Hand flange according to claim 1, characterized in that on its circumference are provided numerous holes (12) for the non-rotary displacement of the attached part (11).

9. Hand flange according to claim 6, characterized in that the attached part (11) is fixed in a specific angular position by plugging a pin (14) into one of the holes (12).

10. Hand flange according to claim 7, characterized in that the pin (14) is elastically mounted on the attached part (11), accompanied by radially inwardly acting spring tension.
